(19) United States
(12) Patent Application Publication
(10) Pub. No.: US 2009/0020042 A1
(43) Pub. Date: Jan. 22, 2009

(54) Use of Nanoparticles for the Preparation of Water-Based Dispersion Adhesives

(75) Inventors: David-Christopher Glende, Gottingen (DE); Karl Kohler, Diekholzen (DE); Jai-Won Park, Gottingen (DE); Ferdinand Hardinghaus, Bad Honnef (DE)

Correspondence Address: Solvay North America, LLC;c/o Kim Manson, Esq., 4500 McGinnis Ferry Road, Alpharetta, GA, 30005, US

(73) Assignee: Solvay Infra Bad Hoenningen GmbH, Hannover (DE)

(21) Appl. No.: 12/278,453

(22) PCT Filed: Feb. 5, 2007
(86) PCT No.: PCT/EP07/51075

§ 371 Date: Aug. 6, 2008

(30) Foreign Application Priority Data
Feb. 8, 2006 (EP) 06101419.7

(51) Int. Cl. C09J 11/04; C08K 3/16; C08K 3/20; C08K 3/26; C08K 3/30; C08K 3/32

(52) U.S. Cl. 106/425; 106/401; 106/432; 106/450; 106/461; 106/479; 106/480; 106/481; 106/462; 106/464; 106/482; 106/447; 106/460; 106/465; 106/491; 106/505; 524/406; 524/413; 524/414; 524/423; 524/424; 524/425; 524/430; 524/432; 524/434; 524/284

(57) ABSTRACT

The present invention relates to the use of nanoparticles for the preparation of water-based dispersion adhesives, and especially the use of finely divided barium sulfate therein. The nanoparticles can be used with or without chemical modification. Adhesives of this kind feature improved properties, examples being improved cohesion in conjunction with comparable adhesion and higher heat resistance. Preference is given to dispersion adhesives based on polyacrylate, polyurethane, and epoxy resin.

The present invention relates to the use of nanoparticles for the preparation of a water-based dispersion adhesive, and especially the use of finely divided barium sulphate therein.

The use of barium sulphate as a filler for plastics is already known. International patent application WO 00/14165 discloses the preparation of barium sulphate embedded in finely divided form in a carrier material. The particle size is 0.01 to 10 μm; they have good properties in connection with matting. Production takes place by wet fine milling in the presence of the carrier material.

International patent application WO 02/30994 discloses the addition of an inorganic barium sulphate of this kind to raw materials for polymers, prior to the formation of polymer. The preferred average particle size D₅₀ of the inorganic solid embedded into the organic substance is 0.25 to 0.45 μm. he additive compositions are used in polyester and polyamide.

International patent application WO 00/57932 discloses materials for surgical application that contain what are referred to as nanocomposites. The filler particles can be treated with organic compounds in order to enhance their dispersibility, to reduce their propensity to agglomerate or aggregate, and to enhance the uniformity of the dispersion. Examples of compounds employed for this purpose include organic compounds such as the monomer of the surgical material under production, citrates or other compounds. Use may also be made of coupling agents such as organosilanes or of polymeric materials such as surfactants, an example being sodium dodecyl sulphate, but also of amphiphilic molecules, i.e. molecules which have a hydrophilic part and a hydrophobic part. Those specified include nonylphenol ethoxylates; bis(2-ethylhexyl) sulphosuccinate; hexadecyltrimethylammonium bromide; and phospholipids. The examples use either uncoated barium sulphate or particles coated following precipitation with sodium citrate.

WO 2005/054133 discloses chemically modified barium sulphate which can be used for incorporation into adhesives, among other possible uses.

It was an object of the present invention to provide an adhesive having particularly advantageous properties. This object is achieved through the dispersion adhesive of the invention.

The present invention therefore relates to the use of nanoparticles for the preparation of water-based dispersion adhesives, where the nanoparticles have a primary particle size smaller than or equal to 500 nm and, where at least part of the primary particles may be present in the form of secondary particles, the secondary particles having a size smaller than or equal to 1000 nm.

Indeed, it has been surprisingly found that adhesives of this kind feature improved properties, such as increased cohesion and/or higher thermal stability.

The invention provides a water-based dispersion adhesive which is characterized by the presence therein of nanoparticles having an average primary particle size of less than or equal to 500 nm, preferably less than or equal to 400 nm, more preferably less than or equal to 100 nm, whith very particular preference less than or equal to 50 nm, and, where secondary particles are present, having a secondary particle size of less than or equal to 1000 nm. With preference 90% or more of all the particles (agglomerated secondary particles and unagglomerated primary particles) have a size less than or equal to 500 nm, more preferably less than or equal to 400 nm, with very particular preference less than or equal to 100 nm; more preferably still, 90% or more of all the particles have a size less than or equal to 80 nm, especially less than or equal to 50 nm, and even less than or equal to 30 nm.

It is known that certain inorganic particles, in the course of their conventional preparation (precipitation), can form agglomerates (secondary particles) made up of primary particles. The nanoparticles of the invention may contain agglomerates (secondary particles) having a size of less than or equal to 1000 nm. Preferably, 90% or more of all the particles (agglomerated secondary particles and unagglomerated primary particles) have a size of less than or equal to 500 nm, preferably less than or equal to 400 nm, more preferably less than or equal to 250 nm, in particular less than or equal to 100 nm, more preferably less than or equal to 80 nm; more preferably still, 90% or more of all the particles have a size less than or equal to 50 nm, and even less than or equal to 30 nm.

The size of the particles (secondary particles and non agglomerated primary particles, without differenciation between the agglomerated secondary particles and the unagglomerated primary particles) can be measured by various techniques, like for instance Dynamic Light Scattering (DLS) technique (standard ISO-DIS 22412, 2006), or Centrifugal Liquid Sedimentation method (standard ISO 13318-2, 2001). Such methods lead to various informations, such as the particle size distribution, the maximal particle size and the average particle size. These methods allow consequently to measure the maximal size of the secondary particles.

When analysed by the Dynamic Light Scattering (DLS) technique (standard ISO-DIS 22412, 2006), the nanoparticles of the invention have a size of less than or equal to 1000 nm. Preferably, 90% or more of all the particles (agglomerated secondary particles and unagglomerated primary particles) have a size of less than or equal to 500 nm, preferably less than or equal to 400 nm, more preferably less than or equal to 250 nm, in particular less than or equal to 100 nm, more preferably less than or equal to 80 nm; more preferably still, 90% or more of all the particles have a size less than or equal to 50 nm, and even less than or equal to 30 nm.

When analysed by the Centrifugal Liquid Sedimentation method (standard ISO 13318-2, 2001), the nanoparticles of the invention have a size of less than or equal to 1000 nm. Preferably, 90% or more of all the particles (agglomerated secondary particles and unagglomerated primary particles) have a size of less than or equal to 500 nm, preferably less than or equal to 400 nm, more preferably less than or equal to 250 nm, in particular less than or equal to 100 nm, more preferably less than or equal to 80 nm; more preferably still, 90% or more of all the particles have a size less than or equal to 50 nm, and even less than or equal to 30 nm.

The average primary particle size of the nanoparticles according to the invention can be measured by X-ray diffraction (XRD line broadening) technique. When analysed by X-ray diffraction technique, the nanoparticles of the invention have an average primary particle size of less than or equal to 500 nm, preferably less than or equal to 400 nm, more preferably less than or equal to 100 nm, whith very particular preference less than or equal to 50 nm, especially less than or equal to 20 nm, especially preferred being those with an average primary particle size of less than or equal to 10 nm. A frequently observed, production-related lower limit on the primary particle size is 5 nm, for example, but may also be lower. The nanoparticles are partly or even substantially completely in the form of unagglomerated primary particles.

The nanoparticles in the present invention are salts of metals. Preference is given to those salts of metals which have a low solubility in water and/or organic solvents. “Low solubility” means preferably that less than 1 g/l, preferably less than 0.1 g/l, dissolves at room temperature (20° C.). Very particularly preferred salts are those which have a low solubility in water and organic solvents.

Preferred nanoparticles contain cations selected from main group 1 of the Periodic Table of the Elements, particular preference being given to Cu, Ag and Au; from main groups 2 and 3 of the Periodic Table of the Elements, particular preference being given to Mg, Ca, Sr, Ba, Zn, In and Al; from main group 4 of the Periodic Table of the Element, particular preference being given to Ti, Zr, Si, Ge, Sn and Pb; and from main group 6 of the Periodic Table of the Elements, preferably Cr and W. Particularly preferred cations are also metals from the transition groups of the Periodic Table of the Elements, including the lanthanoid metals. The invention also relates to mixtures of such cations.

The anions are preferably selected from the group consisting of PO₄³⁻, SO₄²⁻, CO₃²⁻, F⁻, O²⁻ and OH⁻, including compounds having two or more of these anions, such as oxifluorides, and also hydrates of salts and mixtures thereof.

Specific nanoparticles which are good to use are selected from the group consisting of BaSO₄, SrSO₄, MgCO₃, CaCO₃, BaCO₃, SrCO₃, Zn₃(PO₄)₂, Ca₃(PO₄)₂, Sr₃(PO₄)₂, Ba₃(PO₄)₂, Mg₂(PO₄)₂, SiO₂, Al₂O₃, MgF₂, CaF₂, BaF₂, SrF₂, TiO₂, ZrO₂, fluorides and oxifluorides of lanthanide metals, and also alkali metal fluorometallates and alkaline earth metal fluorometallates and mixtures thereof, such as BaSO₄/CaCO₃ mixture. An example of mixed salt is BaTiO₃.

The nanoparticles are preferably selected from barium sulphate and strontium carbonate. Very particular preference is given to barium sulphate as the nanoparticles to be used. The nanoparticles may be of natural origin. For example, barium sulphate may be natural barite. The nanoparticles may be dry-ground or ground in suspension beforehand. Synthetic nanoparticles are preferred. Precipitated nanoparticles are more preferred. For example, barium sulphate may be obtained by precipitation starting from various sources of barium ions and sulphate ions. The precipitation may be performed starting from solutions, suspensions or emulsions containing one or more precursors of the barium and sulphate ions. For example, barium sulphate can be precipitated by reacting barium chloride or barium hydroxide solutions with alkali metal sulphate or sulphuric acid.

Dispersion adhesives is the term used in the present invention to refer to polymers and copolymers which are present in dispersion in water with particle sizes of around 50 nm to 1 μm. They are used primarily for the adhesive bonding of somewhat absorbent substrates, but are also serving increasingly, on account of their freedom from organic solvents, for the production of sheet laminations (production of single-sided and double-sided adhesive tapes). After the application of the dispersion adhesive to a substrate, the water evaporates and the dispersion particles in the adhesive approach one another until finally they interdiffuse and form an impervious film of adhesive.

Dispersion adhesives, particularly their chemical composition, their production and their application, are known to a person skilled in the art. Certain fundamental information on the chemical composition, and certain auxiliaries, such as plasticizers, are found in Ullmann's Encyclopedia of Industrial Chemistry, Vol. A1 (1985), especially pages 229 to 232 and 239. By way of example, dispersions of homopolymers of vinyl acetate and of vinyl propionate and their copolymers with ethylene or maleic esters can be used as base material for the dispersion adhesives of the invention.

Fundamental information on aqueous dispersions, their preparation and use of adhesives is found in the book “Wassrige Polymerdispersionen” by Dieter Distler (1999), pages 1 to 28 and 125 to 169. Polymer dispersions in water are typically prepared by emulsion polymerization. A stabilized emulsion of monomers is polymerized by adding an initiator while heating. An alternative is to dissolve polymers in solvents, to emulsify these solutions in water, and to remove the solvent under reduced pressure. In this way it is possible for example to produce an aqueous dispersion of PU.

Three classes of adhesive are particularly preferred: adhesive dispersions containing polymers or copolymers selected from the group consisting of polyacrylates, polyurethanes (PU), and epoxy resins, and mixtures thereof. Also embraced are corresponding copolymers containing at least 30% by weight acrylate or PU and including other monomers. Acrylate and PU can of course be composed of one, two or more kinds of monomer; for example, copolymers of methacrylate and butyl acrylate can be employed.

The solid content in the aqueous dispersion is commonly 40% to 60% by weight of adhesive.

The amount of nanoparticles in the aqueous dispersion ought to be calculated such that the desired effect is obtained. Conventionally the amount of nanoparticles in the adhesive (based on the solids) is in the range from 3% to 25% by weight.

It is possible to use nanoparticles which have not been chemically modified. The nanoparticles are preferably subjected to a comminuting operation, such as a wet deagglomeration, for example. The liquid selected can be water or an organic liquid - for example, an alcohol, a hydrocarbon or a halogenated (hydro)carbon. The comminution or deagglomeration may be carried out for example in a stirring or mixing apparatus or a mill, such as in a bead mill, a vibratory mill, an agitator-mechanism mill, a planetary ball mill or a dissolver with glass balls. A process of this kind, without using a dispersant, is described in DE-A 19832304. In that process, the particles to be deagglomerated are introduced into a grinding vessel together with loose grinding media and are comminuted to the desired fineness. Grinding assistants used include, for example, carbon dioxide ice or deep-cooled 1,1,1,2-tetrafluoroethane or similar substances. Examples of suitable mills include ball mills, vibratory mills, agitator mills and planetary ball mills. In this case particle sizes even of below 20 nm are achieved. This process is especially suitable for barium sulphate and other salts among those mentioned, such as SrSO₄, MgCO₃, BaCO₃, SrCO₃, CaCO₃, MgF₂ or CaF₂.

The comminuted nanoparticles can then be used in sufficiently fine form in dispersion adhesives.

It is preferred, however, to use chemically modified nanoparticles. The chemical modification of the nanoparticles is preferably brought about by at least one crystallization inhibitor, by at least one dispersant or by a mixture thereof. It is especially suitable to use chemically modified barium sulphate.

Nanoparticles, and especially nanoscale barium sulphate, is referred to as chemically modified for the purposes of the present invention if in the course of their precipitation, or after their precipitation, they have been contacted with agents which in the course of precipitation inhibit crystal enlargement, and/or if during or after the precipitation they have been contacted with a dispersant. Preferred dispersants are those which even after drying of the dispersant-containing nanoparticles from aqueous or organic suspension allow a redispersion in water or organic solvents to give the nanoscale particles originally obtained.

A chemically modified barium sulphate particularly suitable for use in the context of the present invention is disclosed in the aforementioned WO 2005/054133. The barium sulphate described therein has been surface-modified by means of a dispersant; with preference the barium sulphate has been precipitated in the presence of a crystallization inhibitor. With the mode of preparation described therein, deagglomerated barium sulphate is obtained in the form of very small secondary particles, and in many cases, even after being dried, can easily be redispersed to give the original particles. The reason why this is advantageous is that the primary particles of barium sulphate, despite being situated per se in the nanometer range, have a propensity to form large secondary particles. An explanation is given below of how the barium sulphate whose use is preferred in the present invention can be prepared. A detailed description is found in the cited WO 2005/054133.

Preferred nanoparticles are obtainable by precipitating them in the presence of a crystallization inhibitor, with a dispersant being present during the precipitation and/or with the nanoparticles being deagglomerated after precipitation in the presence of a dispersant.

The amount of crystallization inhibitor and dispersant in the deagglomerated nanoparticles is flexible. Crystallization inhibitor and dispersant are present preferably in an amount of 0.05% to 50%, more preferably in an amount of 1% to 25% by weight each in the deagglomerated nanoparticles. The amount of salts of metal present is preferably from 20% to 80% by weight.

It is preferred in the present invention to use deagglomerated, redispersible nanoparticles. The term “deagglomerated” in this context does not mean that the secondary particles have been broken down completely into primary particles which exist in isolation. It means that the secondary particles are not in the same agglomerated state in which they are typically produced in precipitations, but instead are in the form of smaller agglomerates. The deagglomerated nanoparticles may contain agglomerates (secondary particles). Where secondary particles are present, at least 90% or more of all the particles (agglomerated secondary particles and unagglomerated primary particles) have a particle size of less than or equal to 500 nm, in particular less than or equal to 400 nm, very particularly less than or equal to 200 nm. More preferably still, at least 90% or more of all the particles are smaller than or equal to 130 nm, with particular preference smaller than or equal to 100 nm, with very particular preference smaller than or equal to 80 nm; even more preferably, 90% or more of all the particles have a size smaller than or equal to 50 nm, and even smaller than or equal to 30 nm. In part or even in substantial entirety the nanoparticles are in the form of unagglomerated primary particles. The particle sizes in question are those determined by XRD or laser diffraction methods.

The nanoparticles used according to the invention usually have a BET surface area of at least 10 m²/g, especially of at least 20 m²/g, preferably of at least 30 m²/g, in particular at least 40 m²/g, with particular preference at least 45 m²/g and with very particular preference at least 50 m²/g. The BET specific surface area of the particles is measured according to ISO standard 9277-1995.

Preferred crystallization inhibitors have at least one anionic group. The anionic group of the crystallization inhibitor is preferably at least one sulphate, at least one sulphonate, at least one (preferably at least two) phosphate, at least two phosphonate or at least two carboxylate group(s).

Crystallization inhibitors present may be, for example, substances that are known to be used for this purpose, examples being relatively short-chain or else longer-chain polyacrylates, typically in the form of the sodium salt; polyethers such as polyglycol ethers; ether sulphonates such as lauryl ether sulphonate in the form of the sodium salt; esters of phthalic acid and of its derivatives; esters of polyglycerol; amines such as triethanolamine; and esters of fatty acids, such as stearic esters, as specified in WO 01/92157.

As crystallization inhibitor it is also possible to use a compound of the formula (I) or a salt thereof, having a carbon chain R and n substituents [A(O)OH]

R[—A(O)OH]ₙ (I)

in which
R is an organic radical which has hydrophobic and/or hydrophilic moieties, R being a low molecular mass, oligomeric or polymeric, optionally branched and/or cyclic carbon chain which optionally contains oxygen, nitrogen, phosphorus or sulphur as heteroatoms, and/or being substituted by radicals which are attached via oxygen, nitrogen, phosphorus or sulphur to the radical R, and
A being C, P(OH), OP(OH), S(O) or OS(O), and n being 1 to 10 000.

In the case of monomeric or oligomeric compounds, n is preferably 1 to 5.

Useful crystallization inhibitors of this kind include hydroxy-substituted carboxylic acid compounds. Examples include hydroxy-substituted monocarboxylic and dicarboxylic acids. Such carboxylic acids preferably have 1 to 20 carbon atoms in the chain (reckoned without the carbon atoms of the COO groups), such as citric acid, malic acid (2-hydroxybutane-1,4-dioic acid), dihydroxysuccinic acid and 2-hydroxyoleic acid, for example. Very particular preference is given to citric acid and polyacrylate, such as Dispex® N40 (from CIBA), as crystallization inhibitor.

Also very useful are phosphonic acid compounds having an alkyl (or alkylene) radical with a chain length of 1 to 10 carbon atoms. Useful compounds in this context are those having one, two or more phosphonic acid radicals. They may additionally be substituted by hydroxyl groups. Highly useful examples include 1-hydroxyethylenediphosphonic acid, 1,1-diphosphonopropane-2,3-dicarboxylic acid and 2-phosphonobutane-1,2,4-tricarboxylic acid. These examples show that compounds having not only phosphonic acid radicals but also carboxylic acid radicals are likewise useful.

Also very useful are compounds which contain 1 to 5 or an even greater number of nitrogen atoms and also 1 or more, for example up to 5, carboxylic acid or phosphonic acid radicals and which are optionally substituted additionally by hydroxyl groups. These include, for example, compounds having an ethylenediamine or diethylenetriamine framework and carboxylic acid or phosphonic acid substituents. Examples of highly useful compounds include diethylentriaminepentakis(methanephosphonic acid), iminodisuccinic acid, diethylenetriaminepentaacetic acid and N-(2-hydroxyethyl)ethylenediamine-N,N,N-triacetic acid.

Also very useful are polyamino acids, an example being polyaspartic acid.

Also very useful are sulphur-substituted carboxylic acids having 1 to 20 carbon atoms (reckoned without the carbon atoms of the COO group) and 1 or more carboxylic acid radicals, an example being sulphosuccinic acid bis-2-ethylhexyl ester (dioctyl sulphosuccinate).

The crystallization inhibitor is preferably an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphonosphonic acid; ethylenediamine or diethylenetriamine derivatives containing at least one carboxylic acid or phosphonic acid and optionally substituted by hydroxyl groups; or salts thereof.

It is of course also possible to use mixtures of the additives, including mixtures, for example, with further additives such as phosphorous acid.

The preparation of the above-described nanoparticle intermediates with the crystallization inhibitors, particularly those of the formula (I), is advantageously carried out by precipitating the nanoparticles in the presence of the envisaged crystallization inhibitor. It can be advantageous if at least part of the inhibitor is deprotonated; for example, by using the inhibitor at least in part, or entirely, as an alkali metal salt, a sodium salt for example, or as an ammonium salt. Naturally it is also possible to use the acid and to add a corresponding amount of the base, or in the form of an alkali metal hydroxide solution.

In a preferred embodiment, the deagglomerated nanoparticles comprise not only the crystallization inhibitor but also an agent which has a dispersing action. This dispersant prevents the formation of undesirably large agglomerates when added during the actual precipitation. As will be described later on below, it can also be added in a subsequent deagglomeration stage; it prevents reagglomeration and ensures that agglomerates are readily redispersed.

The dispersant preferably has one or more anionic groups which are able to interact with the surface of the nanoparticles. Such anionic groups will act as anchor groups for the surface of the nanoparticles. Preferred groups are the carboxylate group, the phosphate group, the phosphonate group, the bisphosphonate group, the sulphate group and the sulphonate group.

Dispersants which can be used include some of the above-mentioned agents which as well as a crystallization inhibitor effect also have a dispersing effect. When agents of this kind are used, it is possible for crystallization inhibitor and dispersant to be identical. Suitable agents can be determined by means of routine tests. The consequence of agents of this kind with a crystallization inhibitor effect and dispersing effect is that the precipitated nanoparticles are obtained as particularly small primary particles and forms readily redispersible agglomerates. Where an agent of this kind having both crystallization inhibitor effect and dispersing effect is used, it may be added during the precipitation and, if desired, deagglomeration may additionally be carried out in its presence.

It is usual and preferable to use different compounds having crystallization inhibitor effect and dispersing effect.

Very advantageous deagglomerated nanoparticles are that comprising dispersants of a kind which endow them with a surface which prevents reagglomeration and/or inhibits agglomeration electrostatically, sterically, or both electrostatically and sterically. Where such a dispersant is present during the actual precipitation, it inhibits the agglomeration of the precipitated nanoparticles, so that deagglomerated nanoparticles are obtained even at the precipitation stage. Where such a dispersant is incorporated after the precipitation, as part of a wet-grinding operation, for example, it prevents the reagglomeration of the deagglomerated nanoparticles after the deagglomeration. Nanoparticles comprising a dispersant of this kind are especially preferred on account of the fact that they remain in the deagglomerated state.

Particularly advantageous deagglomerated nanoparticles are characterized in that the dispersant has at least one carboxylate, phosphate, phosphonate, bisphosphonate, sulphate or sulphonate group which is able to interact with the nanoparticle surface (anchor group for the surface of the nanoparticles). Preferably, the dispersant contains one or more organic radicals R¹ which have hydrophobic and/or hydrophilic moieties.

Preferably R¹ is a low molecular mass, oligomeric or polymeric, optionally branched and/or cyclic carbon chain which optionally contains oxygen, nitrogen, phosphorus or sulphur heteroatoms and/or is substituted by radicals which are attached via oxygen, nitrogen, phosphorus or sulphur to the radical R¹ and the carbon chain is optionally substituted by hydrophilic or hydrophobic radicals. One example of substituent radicals of this kind are polyether or polyester based side chains. Preferred polyether based side chains have 3 to 50, preferably 3 to 40, in particular 3 to 30 alkyleneoxy groups. The alkyleneoxy groups are preferably selected from the group consisting of methyleneoxy, ethyleneoxy, propyleneoxy and butyleneoxy groups. The length of the polyether based side chains is generally from 3 to 100 nm, preferably from 10 to 80 nm.

Preferred nanoparticles comprise a dispersant which has groups for coupling to or into polymers. Such groups will act as anchor groups for the polymer matrix. These may be groups which bring about this coupling chemically, examples being OH, NH, NH₂, SH, O—O peroxo, C—C double bond or 4-oxybenzophenone propylphosphonate groups. The groups in question may also be groups which bring about physical coupling.

An example of a dispersant which renders the surface of the nanoparticles hydrophobic is represented by phosphoric acid derivatives in which one oxygen atom of the P(O) group is substituted by a C3-C10 alkyl or alkenyl radical and a further oxygen atom of the P(O) group is substituted by a polyether side chain. A further acidic oxygen atom of the P(O) group is able to interact with the nanoparticle surface.

The dispersant may be, for example, a phosphoric diester having a polyether or a polyester based side chain and an alkenyl group as moieties. Alkenyl groups with 4 to 12, in particular 4 to 6 carbon atoms are highly suitable. Phosphoric esters with polyether/polyester side chains such as Disperbyk® 111 (BYK-Chemie), phosphoric ester salts with polyether/alkyl side chains such as Disperbyk® 102 and 106, substances having a deflocculating effect, based for example on high molecular mass copolymers with acidic groups possessing pigment affinity, such as Disperbyk® 190, or polar acidic esters of long-chain alcohols, such as Disperplast® 1140, are further highly useful types of dispersants.

Nanoparticles having especially good properties comprise as dispersant a polymer which has anionic groups which are able to interact with the surface of the nanoparticles (anchor groups for their surface), examples being the groups specified above, and contains groups for coupling to or into polymers such as OH, NH, NH₂, SH, O—O peroxo, C—C double bond or 4-oxybenzophenone propylphosphonate groups (anchor groups for the polymer matrix). Preferably there are polyether or polyester based side chains present which contain OH, NH, NH₂, SH, O—O peroxo, C—C double bond or 4-oxybenzophenone propylphosphonate groups. Nanoparticles of this kind according to the invention exhibit no propensity to reagglomerate. In the course of the application there may even be further deagglomeration.

As as result of the substitution with polar groups, especially hydroxyl groups and amino groups, the nanoparticles are externally hydrophilicized.

Preferred dispersants contain at least one anionic group which will act as an anchor group for the surface of the nanoparticles, at least one polyether or polyester based side chain that prevents reagglomeration sterically, and at least one group which will act as an anchor group for the polymer matrix.

The groups used for coupling to or into polymers can be preferentially selected with regard to the nature of the polymer matrix. The polar groups, especially hydroxyl groups and amino groups, represent reactive groups. Especially good properties are exhibited by nanoparticles coated with a dispersant which has a multiplicity of polycarboxylate groups and a multiplicity of hydroxyl groups and also has further substituents which are sterically bulky, examples being polyether or polyester based side chains. A very preferred group of dispersants are polyether polycarboxylates substituted terminally on the polyether based side chains by hydroxyl groups, examples being those supplied under the name Melpers® of the company SKW/DEGUSSA (now BASF). Hydroxyl groups car notably suitable for coupling to or into epoxy resins or polyurethanes.

Nanoparticles of this kind, having a crystal growth inhibitor and one of the particularly preferred dispersants that prevents reagglomeration sterically, especially a dispersant substituted by polar groups as described above, has the great advantage that it comprises very fine primary particles and comprises secondary particles whose degree of agglomeration is low at most, these particles, since they are readily redispersible, having very good application properties—for example, they can be incorporated readily into polymers and do not tend towards reagglomeration, and indeed even undergo further deagglomeration in the course of the application.

At the time of incorporation into the adhesive base, the deagglomerated coated nanoparticles are advantageously in the form of a dispersion in water, preferably in an amount of 0.1% to 60% by weight, for example 0.1% to 25% by weight, or 1% to 20% by weight.

The preparation of highly suitable nanoparticles is described in international patent application PCT/EP2006/062860. As far as barium sulphate is concerned, its preparation is described in detail in WO 2005/054133. The texts of those two applications are incorporated herein by reference. By way of example, the nanoparticles can first be precipitated using a crystallization inhibitor, and then in a second step the dispersant is incorporated, by means for example of intimate deagglomeration in a bead mill in the presence of a dispersant. Alternatively the precipitation itself can take place in the presence of a dispersant and, if desired, an additional treatment may follow with dispersant, again in a suitable comminution apparatus such as a bead mill.

The deagglomeration is preferably continued until the deagglomerated nanoparticles have secondary particles in the desired size. The deagglomeration can be carried out in the presence of water, as a wet deagglomeration. The dispersion formed in the course of wet deagglomeration can be incorporated, where appropriate after adjustment to the nanoparticles concentration, into the adhesive dispersion.

It is also possible to perform a drying operation, by means of spray drying, for example. The particles formed in this case break down again very easily into the deagglomerated nanoparticles. The nanoparticles of the invention are formed from very small primary particles; the secondary particles are situated in deagglomerated state; and it is redispersible. It can then be incorporated, as a dry material or after renewed suspension, into the adhesive dispersion. If the especially preferred polymeric dispersants are employed which prevent reagglomeration sterically and have polar groups for coupling to or into polymers, then further deagglomeration is in fact observed on resuspension.

In order to generate the dispersion adhesives of the invention it is possible to incorporate the nanoparticles, dry or as an aqueous dispersion, into a dispersion of an adhesive, with stirring. It would indeed be possible to add the nanoparticles, in the form of a suspension in an organic solvent, to the dispersion adhesive, and then to evaporate off the organic solvent; however, this is inconvenient.

It has been found that there may be a loss of adhesion and tack, dependent essentially on the concentration of nanoparticles and on the dispersant used. This loss of adhesion and/or tack, however, is not serious. The trend which emerges with regard to the dynamic shear strength and the static shear strength, as an indicator of the cohesion, is of a significant gain in cohesion, which increases as the concentration of nanoparticles goes up. With a moderate content in nanoparticles, for instance in the range from 10% to 15% by weight of chemically modified nanoparticles, it is found that nanoparticles that have been dispersed by means of a dispersant having relatively long side chains, such as Melpers® 0030 (from SKW/DEGUSSA), have the effect of a relatively large increase in cohesion. It is assumed that the longer side chains are able to enter more into interactions with the polymer chains, and produce a higher dynamic and static shear strength. At higher levels of nanoparticles, 20% by weight or more for example, the gain in cohesion is no longer affected by such side chains, and is comparably high.

A further positive effect is discernible on the thermal stability. A polyacrylate adhesive without nanoparticles added fails from just 100° C. in the thermal stability test. The addition of chemically modified nanoparticles in an amount of 15% by weight raises this figure to more than 200° C. Even PU dispersions are advantageously improved.

The invention further provides, therefore, for the use of the dispersion adhesives of the invention in thermally loaded application fields, such as the car industry. Preferred application fields are those in which continually or occasionally the dispersion adhesive is exposed to a temperature of 50° C. or more, 100° C. or more for example. These include heat-sealing systems, especially those based on PU.

The advantage of the dispersion adhesives of the invention lies in particular in the higher thermal stability and the increased cohesion. Consequently the dispersion adhesives of the invention can be employed in particular wherever there are heightened requirements in terms of thermal stability and/or in terms of cohesion. Another advantage is their transparency.

The present invention further relates to water-based dispersion adhesive obtainable by a process involving the use of the present invention.

The examples which follow are intended to elucidate the invention further without restricting it in its scope.

### EXAMPLES

Examples 1 to 4 are taken from WO 2005/054133 and illustrate the preparation of chemically modified barium sulphate.

### Example 1

Preparation of finely divided barium sulphate as an intermediate by precipitation in the presence of crystallization inhibitors

### General Experimental Instructions

a) Routine experiment:

A high 600 ml glass beaker was charged with 200 ml of additive solution (containing 2.3 g of citric acid and 7.5 g of Melpers® 0030—which possesses a polyethylene glycol side-chain of 38 nm) and 50 ml of sodium sulphate solution with a concentration of 0.4 mol/l. Stirring was carried out centrally in the solution by means of an Ultraturrax stirrer as dispersing aid at 5000 rpm. In the vortex region of the Ultraturrax the barium chloride solution (concentration: 0.4 mol/l) was supplied by means of a Dosimat automatic metering device.

b) Unit (V):

An apparatus was used as described in WO 01/92157, in which forces of thrust, shear and friction act on the reaction mixture. The additive solution was added to the initial charge of the sulphate solution. For other useful crystallization inhibitors refer to the table on pages 31 and 32 of WO 2005/054133.

### Example 2

Preparation of deagglomerated barium sulphate

The barium sulphate prepared in accordance with Example 1 and comprising citric acid as crystallization inhibitor was dried and was subjected to wet grinding in a bead mill with addition of a dispersant (15% by weight) in the presence of water. The dispersant used was a polyether polycarboxylate substituted terminally by hydroxy groups on the polyether side chains (Melpers® 0030 from SKW/DEGUSSA (now BASF), molar weight approximately 20 000, side chain 5800).

The example is repeated using Disperbyk® 190 (from BYK-Chemie), a high molecular mass block copolymer with acidic groups having pigment affinity.

The barium sulphate containing citric acid and deagglomerated with the terminally hydroxy-substituted polyether polycarboxylate, and the product deagglomerated with Disperbyk® 190, proved to be particularly useful for application in dispersion adhesives. It was found that the deagglomerated product (secondary particle size of less than or equal to 80 nm) even underwent further deagglomeration in the course of processing.

### Example 3

Preparation of barium sulphate by precipitation in the presence of crystallization inhibitors and polymeric dispersants during precipitation

Starting materials used were barium chloride and sodium sulphate.
3.1. Beaker experiments:

A 200 ml graduated flask was charged with 7.77 g of the Melpers-type, terminally hydroxy-substituted polyether polycarboxylate (Melpers® 0030) from SKW and made up to 200 ml with water. This quantity corresponded to 50% of Melpers (30% aqueous solution) based on the maximum amount of BaSO₄ formed (=4.67 g).

A 600 ml high glass beaker was charged with 50 ml of a 0.4 M BaCl₂ solution, to which the 200 ml of the Melpers solution were added. To aid dispersion an Ultraturrax was immersed centrally into the glass beaker and operated at 5000 rpm. Within the vortex region created by the Ultraturrax 50 ml of a 0.4 M Na₂SO₄ solution to which citric acid was added (50% of citric acid, based on the maximum amount of BaSO₄ formed : 2.33 g per 50 ml/Na₂SO₄) was added via a flexible tube, using a Dosimat. Both the BaCl₂/Melpers solution and the Na₂SO₄/citric acid solution were rendered alkaline using NaOH prior to precipitation; the pH was approximately 11-12.

The barium sulphate obtained in deagglomerated form possessed a primary particle size, measured by XRD, of approximately 10 to 20 nm; the secondary particle size, measured by Dynamic Light Scattering, was in the same range, and so the barium sulphate was regarded as largely free of agglomerate.
3.2. Preparation of deagglomerated barium sulphate on the pilot plant scale A 30 l vessel was charged with 5 l of a 0.4 M BaCl₂ solution. 780 g of the Melpers product were added with stirring (50%, based on maximum amount of BaSO₄ formed : 467 g). To this solution there were added 20 l of demineralized water. Operated within the vessel was an Ultraturrax, in whose vortex region 5 l of a 0.4 M Na₂SO₄ solution were added via a stainless steel pipe, using a peristaltic pump. The Na₂SO₄ solution was admixed with citric acid beforehand (233 g/5 l Na₂SO₄ =50% citric acid, based on maximum amount of BaSO₄ formed). As in the case of the beaker experiments, both solutions were rendered alkaline by means of NaOH prior to precipitation in these experiments as well. The properties in respect of primary particle size and usefulness corresponded to those of the barium sulphate from Example 3.1. The sulphate was likewise largely free from agglomerates.
3.3. Preparation of deagglomerated barium sulphate with higher reactant concentrations

Example 3.2 was repeated. On this occasion 1-molar solutions were used. The barium sulphate obtained corresponded to that of Example 3.2.

### Example 4

Preparation of barium sulphate with grinding
4.1. Preparation of chemically dispersed barium sulphate by precipitation in the presence of crystallization inhibitors and subsequent grinding in the presence of polymeric dispersants

Starting materials used are barium chloride and sodium sulphate. Barium chloride solution (0.35 mol/l) and sodium sulphate solution (0.35 mol/l) are reacted in the presence of citric acid as crystallization inhibitor, with precipitation of barium sulphate. The precipitated barium sulphate is dried and suspended in water. A polyether polycarboxylate substituted terminally on the polyether side chains by hydroxyl groups (Melpers® 0030) is added as dispersant, and the barium sulphate is deagglomerated in a bead mill.
4.2. Preparation using other starting compounds and a different crystallization inhibitor

Example 4.1. was repeated. Barium chloride was replaced by barium hydroxide solution (0.35 mol/l) and sodium sulphate by sulphuric acid (0.35 mol/l). Instead of citric acid, 3% by weight of Dispex® N40 were used (a sodium polyacrylate). Melpers® 0030 was used in an amount of 8.5% by weight. The resulting barium sulphate exhibited an average primary particle size, measured by XRD, of 36 nm. The average particle size (primary and secondary particles), measured by centrifugal liquid sedimentation, was 68 nm. The barium sulphate particles exhibited a BET surface area, measured according to ISO standard 9277-1995, of 47 m²/g.

### Example 5

Production of an adhesive dispersion with chemically modified barium sulphate
5.1. Production of the adhesive base

### Batch:

| Substance | Amount [g] |
|---|---|
| Water | 192.00 |
| Methacrylic acid | 9.00 |
| Styrene | 70.50 |
| n-Butyl acrylate | 145.50 |
| Sodium lauryl sulphate | 13.75 |

Sodium lauryl sulphate is a surfactant suitable for emulsion polymerization.

Experimental procedure:

A continuously stirred emulsion is produced from the monomers, dispersants and water specified in the table above.

An initiator solution is produced from 0.45 g of sodium peroxodisulphate and 35 g of water.

In a heatable, round-bottomed flask provided with temperature regulation and serving as reactor, 600 g of water are introduced as an initial charge and are heated to approximately 80° C. Then over the course of 240 minutes the emulsion of the monomers and, beginning simultaneously but over 280 minutes, the initiator solution are fed in. After the end of the feeding procedure, polymerization is continued at 80° C. for 1 hour. The resulting dispersion is cooled to room temperature and passed through a 200 μm filter sieve. The solids content is 22% by weight.
5.2. Addition of the chemically modified barium sulphate

Citrate-precipitated barium sulphate with 15% by weight Disperbyk® 190 was used to produce an aqueous dispersion containing 50% by weight of the chemically modified barium sulphate. This suspension was added dropwise with thorough stirring to 364 g of the dispersion obtained in 5.1. The dispersion was diluted with 10 ml of deionized water, passed through an 80 μm filter sieve and degassed under reduced pressure and by means of ultrasound.

The degassed sample was then transferred to a silicone mould, placed in a heating cabinet and, without being moved, was converted at 30° C. into an adhesive film.

The film was then mechanically characterized. The dynamomechanical analysis (DMA) was carried out in an instrument from Bohlin (model CVO 120). The complex shear modulus G was determined by shearing a sample between two parallel plates, in the course of which the polymer film to be analysed was placed between two aluminium discs and sheared at constant frequency and increasing temperature (oscillation). DMA measurements were carried out. The temperature range selected was −20° C.-200° C. For all of the samples, measurements were made of the storage modulus G′, the loss modulus G″, and the tangens delta, for determining Tg. Cooling was carried out with liquid nitrogen.

It was found that, in comparison with a film without barium sulphate added, the stability on extension was somewhat lower but the thermal stability and the cohesion were improved. It was found that the pure acrylate exhibited a distinct loss of modulus at even below 100° C. The film softend severely on increasing temperature and lost almost a power of ten up to 200° C. The thermal stability of this film, accordingly, was poor. In the case of the film containing barium sulphate/Disperbyk® 190, a marked drop in the shear modulus occured much later, at above 130° C., and so the nanoparticle system improved the thermal stability markedly.

### Example 6

Dispersion adhesives based on polyurethane
6.1. With barium sulphate containing Melpers® 0030

Barium sulphate which was precipitated in the presence of Dispex® N 40 and contained this substance in an amount of 3% by weight was suspended in water and beadmilled in the presence of Melpers® 0030. The amount of Melpers® 0030 in the dispersion was 8.5% by weight (based on the dry mass of barium sulphate); the solids content was 50% by weight.

178 g of a polyurethane dispersion in water (BASF Luphen DS 3548, a PU polyester) were admixed dropwise and with vigorous stirring with 40.0 g of the barium sulphate dispersion (50% by weight solids content). Polymer films were then produced in the heating cabinet as described in Example 5. At room temperature the films were hard and opaque, since they were crystalline. At 30 to 40° C. they passed into the amorphous state, became clear, and softened. The barium sulphate was present in the films in an amount of 20% by weight.
6.2. With barium sulphate containing Disperbyk® 190 as dispersant

Example 6.1. is repeated, but with Disperbyk® 190 as dispersant. The amount corresponds to that of Example 6.1.
6.3. Reference film (comparative example)

Example 6.1. was repeated, but without incorporation of barium sulphate. The film formed was used as the reference film.

PU dispersions were used as what are called heat-sealing systems. They softened at 80° C. and in so doing developed a tack; at room temperature, in contrast, they were solid and non-tacky. The problem was their deficient temperature stability. Improved cohesion and improved thermal stability are particularly important in these systems.
Mechanical investigation of the films produced: Investigation of tensile strength/breaking elongation

The investigation was carried out using an instrument from Zwick/Roell. Measurements were performed fundamentally in triplicate.

The dumbbell specimens were produced from the films by punching.

The reference film broke at a lengthwise extension of 700%; the strain on breaking was 1.5 N/mm². The adhesive film of the invention (ex. 6.1 and 6.3) did not break even at a lengthwise extension of 800% of the original length, which amounted to the end of the measurement distance. Its strain for a lengthwise extension of 800% was about 4.5 to 6 N/mm².
Dynamomechanical analysis:

Dynamomechanical analysis (DMA) was again carried out in an instrument from Bohlin (model CVO 120) by shearing a sample between two parallel plates.

Reference sample: A sharp drop was apparent in the storage modulus as a function of the temperature. Thus 10⁴ Pa were crossed at 120° C. The film softened sharply above 100° C. and was virtually liquid at 200° C.

Adhesive film with 20% by weight modified barium sulphate (3% Dispex® N 40, 8.5% by weight Melpers® 0030): a figure of 10⁴ Pa was crossed only at 147° C. There is therefore a markedly improved thermal stability, which is of great advantage for heat-sealing systems.

### Example 6.4

Use of different PU dispersions

Example 6.1. was repeated, but using Luphen D 207 and Luphen DS 3528. These are likewise aqueous, resin-modified, anionic, emulsifier-free emulsions of polyester-PU elastomers. Luphen D 207 is amorphous, DS 3628 has particle diameters of 200 nm. They are used for producing laminating adhesives, contact adhesives and foam adhesives.

For the tensile strength/breaking extension investigation, the films were preheated in an oven at 50° C. for an hour and then taken individually from the oven for each measurement and clamped into the jaws of the investigation instrument. After exactly 60 seconds the measurement was commenced. At that point the films were still in the amorphous state.

Here as well, there was a distinct improvement in properties as compared with the adhesive film free of barium sulphate. From 11 N/mm² in the case of the reference film of Luphen D 207, the force rose to 17 N/mm² in the case of the sample containing barium sulphate. In the case of DS 3258 an increase from 12 to 18 N/mm² was observed.

1. A method of use of nanoparticles for the preparation of water-based dispersion adhesives, wherein the nanoparticles have a primary particle size smaller than or equal to 500 nm and, optionally wherein at least some of the primary particles are present in the form of secondary particles, the secondary particles having a size smaller than or equal to 1000 nm.

2. The method of use according to claim 1, wherein the primary particles are smaller than or equal to 400 nm.

3. The method of use according to claim 1, wherein the secondary particles are present, and wherein 90% or more of all the particles which are agglomerated secondary particles and unagglomerated primary particles have a size smaller than or equal to 500 nm.

4. The method of use according to claim 1, wherein the nanoparticles contain salts of metals.

5. The method of use according to claim 4, wherein the nanoparticles contain cations selected from the group consisting of Cu, Ag, Au, Ti, Zr, Si, Cr, W, Ge, Sn, Pb, Mg, Ca, Sr, Ba, Zn, In, and Al, and mixtures thereof.

6. The method of use according to claim 4, wherein the nanoparticles contain anions selected from the group consisting of PO₄³−, SO₄²−, CO₃²−, F⁻, O²−, OH⁻, compounds containing two or more of these anions, hydrates thereof, and mixtures thereof.

7. The method of use according to claim 4, wherein the nanoparticles are selected from the group consisting of BaSO₄, SrSO₄, MgCO₃, CaCO₃, BaCO₃, SrCO₃, Zn₃(PO₄)₂, Ca₃(PO₄)₂, Sr₃(PO₄)₂, Ba₃(PO₄)₂, Mg₂(PO₄)₂, SiO₂, Al₂O₃, MgF₂, CaF₂, BaF₂, SrF₂, TiO₂, ZrO₂, fluorides of lanthanide metals, oxifluorides of lanthanide metals, alkali metal fluorometallates alkaline earth metal fluorometallates, and mixtures thereof.

8. The method of use according to claim 1, wherein at least some of the nanoparticles are chemically modified nanoparticles, the chemical modification of the nanoparticles being brought about by at least one additive selected from the group consisting of crystallization inhibitors, dispersants, and a mixtures thereof.

9. The method of use according to claim 8, wherein the crystallization inhibitor is selected from compounds having at least one anionic group.

10. The method of use according to claim 9, wherein the anionic group of the crystallization inhibitor is at least one sulfate, at least one sulfonate, at least two phosphates, at least two phosphonates, at least two carboxylate groups, and mixtures thereof.

11. The method of use according to claim 8, wherein the crystallization inhibitor is a compound of the formula (I) or salt thereof having a carbon chain R and n substituents [A(O)OH]
R[−A(O)OH]ₙ (I)
in which R is an organic radical which has hydrophobic and/or hydrophilic moieties, R being a low molecular mass, oligomeric or polymeric, optionally branched and/or cyclic carbon chain which optionally contains oxygen, nitrogen, phosphorous or sulphur heteroatoms, and/or being substituted by radicals which are attached via oxygen, nitrogen, phosphorus or sulphur to the radical R, A being C, P(OH), OP(OH), S(O) or OS(O), and n being 1 to 10 000, preferably 1 to 5.

12. The method of use according to claim 8, wherein the crystallization inhibitor is selected from the group consisting of an optionally hydroxy-substituted carboxylic acid having at least two carboxylate groups; an alkyl sulfate; an alkylbenizenesulfonate; a polyacrylic acid; a polyaspartic acid; an optionally hydroxy-substituted diphosphonic acid; ethylenediamine or diethylenetriamine derivatives containing at least one carboxylic acid or phosphonic acid and optionally substituted by hydroxyl groups; and salts thereof.

13. The method of use according to claim 8, wherein the dispersant has at least one anionic group which is selected from the group consisting of carboxylate, phosphate, phosphonate, bisphosphonate, sulfate, and sulfonate group.

14. The method of use according to claim 8, wherein the dispersant contains one or more organic radicals R¹ which have hydrophobic and/or hydrophilic moieties.

15. The method of use according to claim 14, wherein R¹ is a low molecular mass, oligomeric or polymeric, optionally branched and/or cyclic carbon chain which optionally contains oxygen, nitrogen, phosphorus or sulfur heteroatoins and/or is substituted by radicals which are attached via oxygen, nitrogen, phosphorus or sulfur to the radical R¹ and the carbon chain is optionally substituted by hydrophilic or hydrophobic radicals.

16. The method of use according to claim 8, wherein the dispersant is a phosphoric diester having a polyether or a polyester based side chain and an alkenyl group, as moieties.

17. The method of use according to claim 8, wherein the dispersant contains at least one group for coupling to or into polymers, said group being selected from the group consisting of OH, NH, NH₂, SH, O—O peroxo, C—C double bond, 4-oxybenzophenone propylphosphonate groups, and mixtures thereof.

18. The method of use according to claim 8, wherein the dispersant contains at least one polyether or polyester based side chain.

19. The method of use according to claim 18, wherein the polyether or polyester based side chains contain groups for coupling to or into polymers.

20. The method of use according to claim 8, wherein the dispersant is a polyether polycarboxylate which is substituted terminally on the polyether based side chains by hydroxyl groups.

21. The method of use according to claim 1, wherein the amount of nanoparticles is in the range of from 3% to 25% by weight, based on the total weight of the dispersion adhesive.

22. The method of use according to claim 8, wherein the crystallization inhibitor and/or the dispersant are each present in the nanoparticles in an amount of 1% to 50% by weight in each case, based on the weight of the nanoparticles.

23. The method of use according to claim 1, wherein at least part of the nanoparticles contains barium sulfate or strontium carbonate.

24. The method of use according to claim 1, wherein the dispersion adhesive contains polymers or copolymers selected from the group consisting of polyurethanes, epoxy-resins, polyacrylates, and mixtures thereof.

25. The method of use according to claim 1 for producing water-based dispersion adhesives having improved cohesion and/or improved thermal stability.

26. A water-based dispersion adhesive obtainable by a process involving the method of claim 1.

27. A method of use of the water-based dispersion adhesive according to claim 26 in thermally loaded application sectors including the car industry.
